(19) United States
(12) Patent Application Publication
(10) Pub. No.: US 2013/0110579 A1
(43) Pub. Date: May 2, 2013

(54) COMPARING CONTRACTS WITH DIFFERENT LENGTHS USING UNCERTAINTY INFORMATION

(71) Applicants: Burcu Aydin, Mountain View, CA (US); Kemal Guler, San Jose, CA (US); Mehmet Oguz Sayal, Sunnyvale, CA (US)

(72) Inventors: Burcu Aydin, Mountain View, CA (US); Kemal Guler, San Jose, CA (US); Mehmet Oguz Sayal, Sunnyvale, CA (US)

(21) Appl. No.: 13/282,714

(22) Filed: Oct. 27, 2011

(51) Int. Cl. G06Q 30/02

(52) U.S. Cl. 705/7.28

(57) ABSTRACT

A method performed by a processing system includes comparing contracts having different lengths using uncertainty information corresponding to a non-overlap period between the contracts and providing an output that represents a comparison between the contracts in view of the uncertainty information.

### BACKGROUND

In procurement situations, a buyer often considers different contract options from suppliers to identify the contract that the buyer prefers. Where the length of contract terms are the same, the buyer can generally calculate the total value of each contract and can compare different contracts using the total values. When the contract lengths differ, however, a meaningful comparison of the different length contracts may be more difficult to determine.

### BRIEF DESCRIPTION OF THE DRAWINGS

FIG. 1 is a block diagram illustrating one embodiment of a contract analysis environment for comparing contracts with different lengths.

FIGS. 2A-2B are flowcharts illustrating embodiments of methods for comparing contracts with different lengths.

FIG. 3 is a graphical diagram illustrating an example of comparing contracts with different lengths.

FIG. 4 is a user interface diagram illustrating another example of comparing contracts with different lengths.

FIG. 5 is a block diagram illustrating a processing system configured to implement a contract analysis environment to compare contracts with different lengths.

### DETAILED DESCRIPTION

In the following detailed description, reference is made to the accompanying drawings, which form a part hereof, and in which is shown by way of illustration specific embodiments in which the disclosed subject matter may be practiced. It is to be understood that other embodiments may be utilized and structural or logical changes may be made without departing from the scope of the present disclosure. The following detailed description, therefore, is not to be taken in a limiting sense, and the scope of the present disclosure is defined by the appended claims.

As described herein, a contract analysis environment is provided for comparing the effect of contract length on procurement costs under uncertainty. Where contracts with different contract periods are presented, quantification of the contract length effect on the total procurement cost is desirable to be able to identify the optimal contract. The inherent uncertainties in determining the optimal contract may be handled via a multi-stage stochastic programming approach as described in additional detail below.

A procurement contract usually specifies a purchase price and a purchase quantity (e.g., a minimum and/or maximum purchase amount) for one or more items (e.g., goods and/or services). These contract terms protect the buyer from price fluctuations and guarantee the supplier a steady demand stream during the contract period. At the end of the contract, the buyer and seller may re-negotiate the price and/or quantities according to market conditions.

When different length contracts are available to a buyer or seller, the choice of a longer or shorter contract period may depend on the expected market conditions at the end of contracts. The expected market conditions present uncertainty in comparing the present value of contracts with different contract periods. The uncertainty may include price uncertainties, demand uncertainties, and discount rate uncertainties.

For price uncertainties, if the price of an item is expected to increase substantially in the future, then a longer term contract may reduce the future price risk and be desirable over a shorter term one. Inflation, for example, may be a factor in anticipating that a price will increase over time. If the price of an item is expected to be stable or decrease in the future, then a shorter term contract may be desirable over a longer term one. For example, electronic devices such as digital cameras and computers may have price decreases over time due to technological advancements and availability of newer versions.

For demand uncertainties, longer term contracts may be desirable in stable markets where future purchase amounts may be predicted with relative accuracy. In contrast, short term contracts may be desirable in more volatile markets.

For discount rate uncertainties, longer term contracts may be desirable in environments of increasing discount rates. In contrast, short term contracts may be desirable in environments of decreasing discount rates.

The ability to analytically measure and compare the expected value of each contract option with respect to future uncertainties provides a valuable tool for the decision maker. By calculating the expected value of each contract given the uncertainties using the contract analysis environment described herein, the decision maker can compare contracts with different lengths and identify an optimal contract.

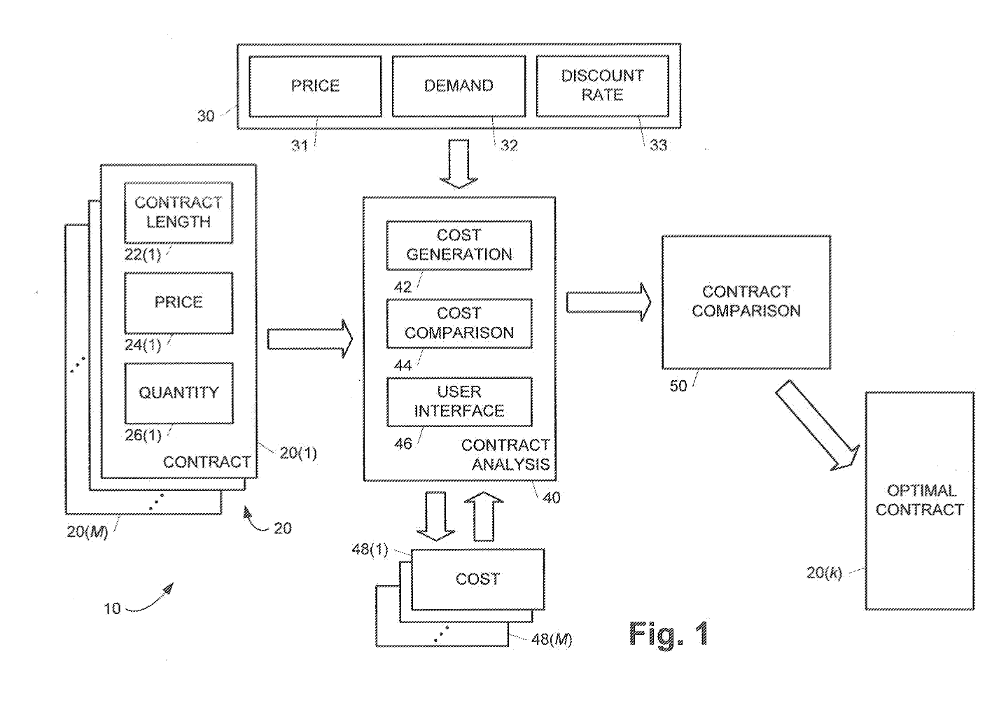

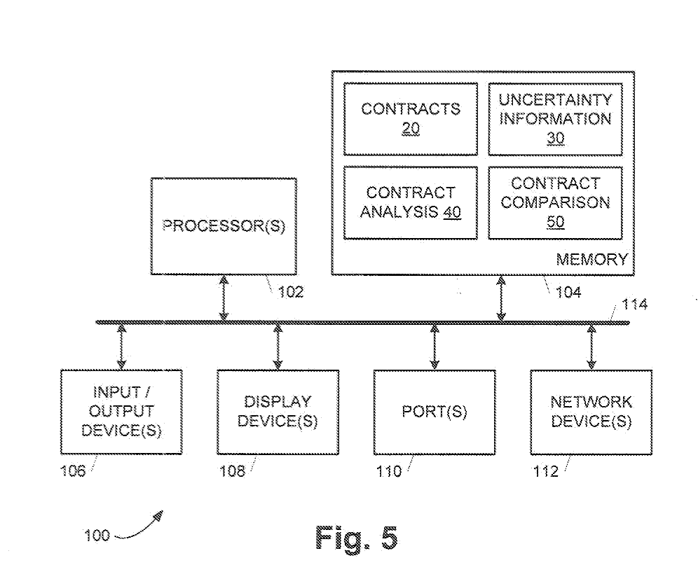

FIG. 1 is a block diagram illustrating one embodiment of a contract analysis environment 10 for comparing a set of contracts 20(1)-20(M) with different lengths, where M is an integer that is greater than or equal to two, given uncertainties represented by uncertainty information 30. As used herein, contracts 20(1)-20(M) may be referred to individually as a contract 20 and collectively as contracts 20. Environment 10 may be implemented using one or more processing systems (e.g., a processing system 100 shown in FIG. 5 and described in additional detail below).

Each contract 20 includes contract information that specifies contract terms including a contract length 22, price information 24, and quantity information 26 for an item (e.g., a good and/or a service). Contract length 22 specifies a length of the term of the contract (e.g., in days, months, years, etc.). Price information 24 specifies a set of one or more prices for the item where each price may correspond to a different period in the contract length 22 (e.g., a different price for each month in a yearlong contract 20). Quantity information 26 specifies an amount of the item to be purchased under the contract 20. The amount may be specified as an actual amount (e.g., 50 items), a range (e.g., a minimum and maximum purchase amount), or other suitable quantity. The amount may be broken down into different amounts for different time period in contract length 22 (e.g., 20 items in January, 25 items in February, etc.).

Uncertainty information 30 includes price uncertainty information 31, demand uncertainty information 32, and/or discount rate uncertainty information 33 for the period or periods where contract lengths 22 of contracts 20 do not overlap (e.g., for the period from the end of the contract 20 with the shortest length 22 to the end of the contract 20 with the longest length 22). As used herein, the period of time where the contract lengths 22 of contracts 20 being compared do not overlap is referred to the non-overlap period of the contracts 20.

Price uncertainty 31 specifies an expected price distribution for one or more non-overlap periods. The price distribution includes a range of expected prices for the item (possibly represented as a single price that is constant) where the range may vary at different times in the non-overlap period or periods. Demand uncertainty 32 specifies an expected demand distribution for one or more non-overlap periods. The demand distribution includes a range of expected purchase amounts for the item (possibly represented as a constant purchase amount) where the range may vary at different times in the non-overlap period or periods. Discount rate uncertainty 33 specifies an expected discount rate distribution for one or more non-overlap periods. The discount rate distribution includes a range of expected discount rates (possibly represented as a single, fixed discount rate) where the range may vary at different times in the non-overlap period or periods.

Contract analysis environment 10 includes a contract analysis unit 40 configured to access contracts 20(1)-20(M) and uncertainty information 30. Contract analysis unit 40 analyzes the set of contracts 20(1)-20(M) using the uncertainty information 30 and generates cost information 48(1)-48(M) for contracts 20(1)-20(M), respectively. Based on cost information 48(1)-48(M), contract analysis unit 40 generates a contract comparison output 50 that directly or indirectly identifies an optimal contract 20(k) from the set of contracts 20(1)-20(M) given uncertainty information 30, where k is an integer greater than or equal to one and less than or equal to M.

Contract analysis unit 40 includes a cost generation unit 42, a cost comparison unit 44, and a user interface unit 46. Cost generation unit 42 generates cost information 48 for each contract 20 for the range of uncertainties presented by uncertainty information 30. Cost generation unit 42 calculates cost information 48 to represent the aggregate expected cost of a corresponding contract 20 discounted to the present value using discount rate uncertainty 33. Thus, cost information 48 includes both the range of aggregate expected costs in periods where the price and quantities are known (i.e., specified by the price and quantity information 24 and 26 of the contract 20) and the range of aggregate expected costs in any non-overlap periods where uncertainty information 30 is used to estimate the costs. For example, to compare two contracts 20(1) and 20(2) where contract length 22(1) is longer than contract length 22(2), cost generation unit 42 calculates cost information 48(1) for contract 28(1) using price information 24(1) and quantity information 26(1) over contract length 22(1). For contract 28(2) (i.e., the shorter term contract), cost generation unit 42 calculates cost information 48(2) for contract 28(2) using price information 24(2) and quantity information 26(2) over contract length 22(2) and using uncertainty information 30 over the non-overlap period between contract length 22(2) and contract length 22(1). Cost generation unit 42 uses a multi-stage stochastic programming approach to calculate the various cost scenarios in cost information 48 that are derived from uncertainty information 30 according to one embodiment.

Cost comparison unit 44 processes cost information 48 corresponding to each contract 20 being compared to generate contract comparison output 50. In particular, cost comparison unit 44 considers each cost scenario determined from uncertainty information 30 in cost information 48 and converts the cost scenarios into output information that allows a user to discern the cost differences between the contracts being compared. The output information may include an explicit indication of the optimal contract 20(k) or may include information that allows the user to identify the optimal contract 20(k). The output information may represent any suitable graphical and/or textual information that may be used to present the cost differences to the user. Cost comparison unit 44 stores the output information as contract comparison output 50.

User interface unit 46 provides contract comparison output 50 to a user using any suitable output device such as a display device on a processing system (e.g., a display device 108 shown in FIG. 5 and described in additional detail below). User interface unit 46 may provide contract comparison output 50 in any suitable graphical and/or textual format to the user. User interface 46 may explicitly identify the optimal contract 20(k) or may present the output information in a way that allows the user to identify the optimal contract 20(k).

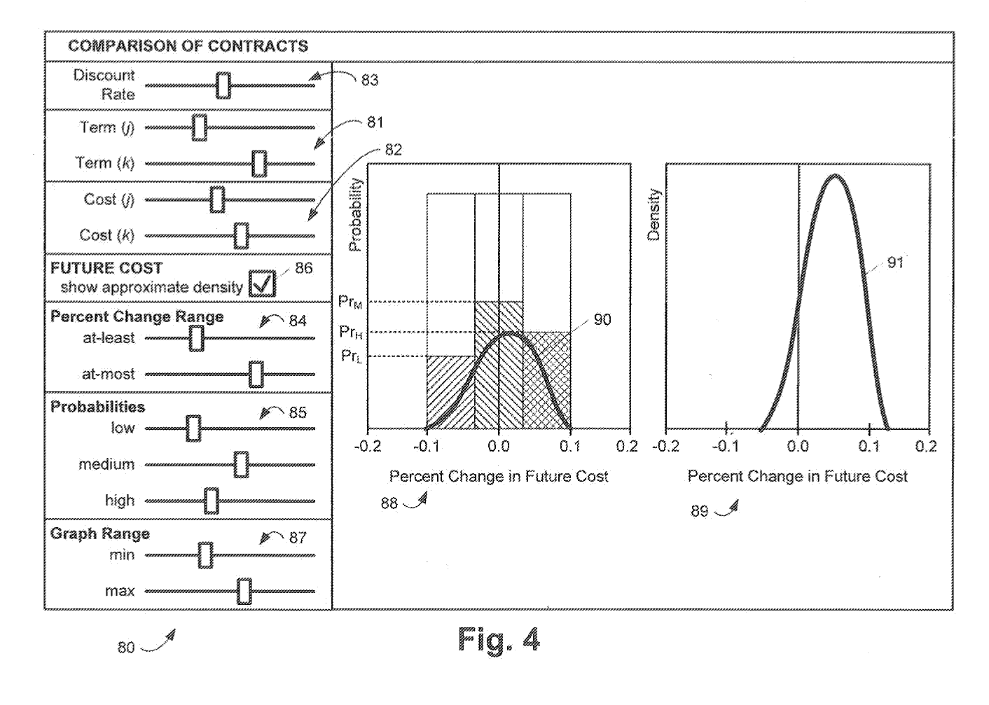

In some embodiments, user interface unit 46 also provides a user with the ability to enter contract information 20, including contract length information 22, price information 24, and/or quantity information 26, and uncertainty information 30, including price uncertainty 31, demand uncertainty 32, and/or discount rate uncertainty 33. User interface unit 46 may provide any suitable data entry tools such as text boxes, slider bars, check boxes, buttons, and/or other suitable textual and/or graphical data entry tools. One example where a user enters contract information 20 and uncertainty information 30 is illustrated and described with reference to FIG. 4 below.

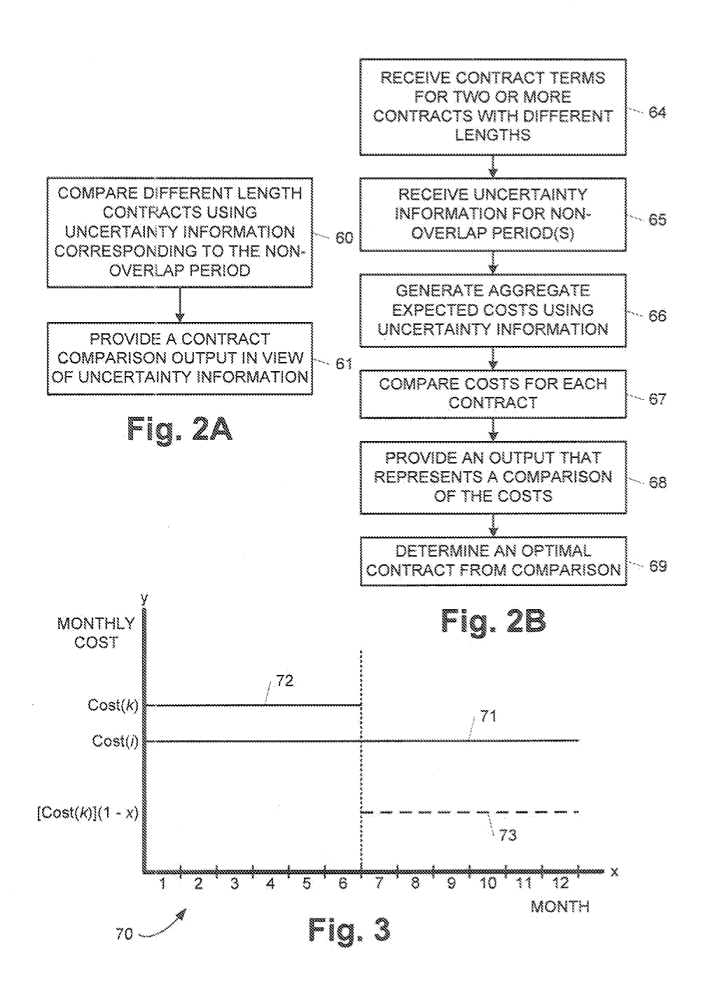

FIGS. 2A-2B are flowcharts illustrating embodiments of methods for comparing contracts with different lengths. The methods of FIGS. 2A-2B will be described with respect to contract analysis unit 40 (shown in FIG. 1) according to one embodiment.

In the embodiment of FIG. 2A, contract analysis unit 40 compares different length contracts 20 using uncertainty information 30 corresponding to the non-overlap period of the contracts 20 as indicated in a block 60. The compared contracts 20 have different lengths 22 where the period of time where the contract lengths 22 of contracts 20 do not overlap is referred to the non-overlap period. The contracts 20 are compared, in one embodiment, by comparing the aggregate expected costs of the contracts 20 discounted to the present value using discount rate 33.

Contract analysis unit 40 provides a contract comparison output 50 in view of uncertainty information 30 as indicated in a block 61. Contract comparison output 50 allows a user to discern which of the contracts 20 is the optimal contract 20(k), given uncertainty information 30. Contract comparison output 50 may be provided as a range of probabilities to the user, particularly where some combination of price uncertainty 31, demand uncertainty 32, and discount rate uncertainty 33 are provided as distributions.

In the embodiment of FIG. 2B, contract analysis unit 40 receives contract terms for two or more contracts 20 with different lengths 22 to be compared as indicated in a block 64. Contract analysis unit 40 also receives uncertainty information 30 for the non-overlap period or periods of the contracts 20 as indicated in a block 65. Cost generation unit 42 generates aggregate an expected cost 48 for each contract 20 using uncertainty information 30 as indicated in a block 66. Cost generation unit 42 discounts each expected cost 48 to the present value using discount rate uncertainty 33 in one embodiment.

Cost comparison unit 44 compares the aggregate expected costs 48 for the contracts 20 and generates contract comparison output 50 as indicated in a block 67. Cost comparison unit 44 generates contract comparison output 50 to include a range of probabilities in embodiments where some combination of price uncertainty 31, demand uncertainty 32, and discount rate uncertainty 33 are provided as distributions. User interface unit 46 provides contract comparison output 50 to the user, where contract comparison output 50 represents a comparison of the aggregate expected costs, as indicated in a block 68. As noted above, the comparison of the aggregate expected costs may be presented as a range of probabilities.

Contract analysis unit 40 determines the optimal contract 20(k) from contract comparison output 50 as indicated in a block 69. In one embodiment, contract analysis unit 40 analyzes the information contract comparison output 50 to determine the optimal contract 20(k) and presents an indication of the optimal contract 20(k) to the user. In other embodiments, contract analysis unit 40 determines the optimal contract 20(k) based on a user input provided in response to the user being presented with contract comparison output 50.

FIG. 3 is a graphical diagram illustrating an example of comparing contracts 20(i) and 20(k) with different lengths 22(i) and 22(k), where i is an integer greater than or equal to one, less than or equal to M, and not equal to k. In this example, length 22(i) is 12 months and length 22(k) is 6 months such that the non-overlap period for contracts 20(i) and 20(k) is from months 7 through 12. Demand, as represented by demand uncertainty 32, is assumed to be a fixed amount for each month over all twelve months and within the ranges of quantities specified by quantity information 26(i) and 26(k). Each contract 20(i) and 20(k) sets a fixed price for each month as represented by price information 24(i) and 24(k) where the price of contract 20(k) is higher than the price of contract 20(i). The discount rate, as represented by discount rate uncertainty 33, is assumed to be a fixed interest rate, r, over all twelve months and is compounded monthly.

With fixed demand and price terms over all 12 months, the monthly cost of contract 200 (i.e., Cost(i)) is constant for each month as indicated by cost information 71 in graph 70. Cost generation unit 42 generates the present value of the aggregate expected cost of contract 20(i) (i.e., Total Cost(i)) using Equation I and stores the aggregate expected cost as cost information 48(i).

$$Total Cost ( i ) = Cost ( i ) {\sum }_{t = 1}^{12} \frac{1}{{( 1 + r / 12 )}^{t}} \qquad Equation I$$

With fixed demand and price terms over the first 6 months, the monthly cost of contract 20(k) (i.e., Cost(k)) for the first 6 months is constant as indicated by cost information 72. Because contract 20(k) is for 6 months, the price becomes uncertain for months 7 through 12. The expected price, as represented by price uncertainty 31, is expressed as a change percent, x, of the price 24(k) of contract 20(k) and is assumed to be constant for months 7 through 12. The change percent, in the example of FIG. 3, is shown as a substantial decrease over price 24(k). With this expected price decrease, the expected monthly cost of contract 20(k) (i.e., Cost(k)) months 7 through 12 is constant as indicated by cost information 73. Accordingly, cost generation unit 42 generates the present value of the aggregate expected cost of contract 20(k) (i.e., Total Cost(k)) using Equation II and stores the aggregate expected cost as cost information 48(k).

$$Total Cost ( k ) = Cost ( k ) {\sum }_{t = 1}^{6} \frac{1}{{( 1 + r / 12 )}^{t}} + Cost ( k ) ( 1 - x ) {\sum }_{t = 7}^{12} \frac{1}{{( 1 + r / 12 )}^{t}} \qquad Equation II$$

In the example of FIG. 3, contract comparison unit 44 determines that the total cost of contract 20(k) is expected to be less than the total cost of contract 20(i) given the substantial price decrease in months 7 through 12. Contract comparison unit 44 stores this determination in contract comparison output 50, and user interface unit 46 provides contract comparison output 50 to a user so that the user may identify contract 20(k) as the optimal contract 20(k) over contract 20(i).

FIG. 4 is a user interface diagram illustrating an example of a user interface 80 generated by user interface 46 (shown in FIG. 1) for comparing contracts 20(j) and 20(k) with different lengths 22(j) and 22(k), where j is an integer greater than or equal to one, less than or equal to M, and not equal to k. In this example, a user enters the terms 22 and total costs (i.e., the prices 24 times the quantities 26 for each contract 20) for contracts 20(j) and 20(k) using sets of slider bars 81 and 82, respectively, such that contract 20(k) has a longer term than contract 20(j) and slightly higher costs than contract 20(j). For the uncertainty information 30, the user sets the discount rate uncertainty 33 to a constant value using slide bar 83 and the price uncertainty 31 to a percent change range of the price of the item using a set of slider bars 84. The user also sets probabilities of the percent change range using a set of slider bars 85 and selects desired graph presentations using a checkbox 86 (i.e., an option to show approximate density of future cost) and a set of slider bars 87 (i.e., a range of graphs 88 and 89). For this example, the demand distribution (i.e., demand uncertainty 32) is assumed to be constant. In other embodiments, demand uncertainty 32 may be entered using additional slider bars or other suitable input features (not shown).

From the user inputs, user interface 46 generates graphs 88 and 89. Graph 88 shows the low (Pr_{L}), medium (Pr_{M}), and high (Pr_{H}) probability levels from slider bars 85 over the percent change range (i.e., −0.1 to +0.1) from slider bars 84 (i.e., the percent change in future cost from price uncertainty 31). Graph 88 also includes a distribution 90 that expresses the selected probabilities over the selected percentage change range. Graph 89 illustrates a density curve 91 over the percentage change range from slider bars 84. Because the bulk of the density curve 91 appears on the positive side of the y-axis, the user may discern there is a greater chance that the shorter term contract 20(j) will be costlier than the longer term contract 20(k). Accordingly, the user may determine that contract 20(k) represents the optimal contract over contract 20(j) based on density curve 91 given the inputs entered by the user for this example. The user may vary the inputs as desired to adjust density curve 91. By doing so, the user may identify other scenarios where contract 20(j) represents the optimal contract over contract 20(k).

FIG. 5 is a block diagram illustrating processing system 100 configured to implement a contract analysis environment 10 (shown in FIG. 1) to compare contracts 20 with different lengths 22 in view of uncertainty information 30.

Processing system 100 includes at least one processor 102 configured to execute machine readable instructions stored in a memory system 104. Processing system 100 may also include any suitable number of input/output devices 106, display devices 108, ports 110, and/or network devices 112. Processors 102, memory system 104, input/output devices 106, display devices 108, ports 110, and network devices 112 communicate using a set of interconnections 114 that includes any suitable type, number, and/or configuration of controllers, buses, interfaces, and/or other wired or wireless connections. Components of processing system 100 (for example, processors 102, memory system 104, input/output devices 106, display devices 108, ports 110, network devices 112, and interconnections 112) may be contained in a common housing (not shown) or in any suitable number of separate housings (not shown).

Processing system 100 may execute a basic input output system (BIOS), firmware, an operating system, a runtime execution environment, and/or other services and/or applications stored in memory 104 (not shown) that includes machine readable instructions that are executable by processors 102 to manage the components of processing system 100 and provide a set of functions that allow other programs (e.g., contract analysis unit 40) to access and use the components.

Processing system 100 represents any suitable processing device, or portion of a processing device, configured to implement the functions of contract analysis unit 40 as described above. A processing device may be a laptop computer, a tablet computer, a desktop computer, a server, or another suitable type of computer system. A processing device may also be a mobile telephone with processing capabilities (i.e., a smart phone), a digital still and/or video camera, a personal digital assistant (PDA), an audio/video device, or another suitable type of electronic device with processing capabilities. Processing capabilities refer to the ability of a device to execute instructions stored in a memory 104 with at least one processor 102.

Each processor 102 is configured to access and execute instructions stored in memory system 104. Each processor 102 may execute the instructions in conjunction with or in response to information received from input/output devices 106, display devices 108, ports 110, and/or network devices 112. Each processor 102 is also configured to access and store data in memory system 104.

Memory system 104 includes any suitable type, number, and configuration of volatile or non-volatile storage devices configured to store instructions and data. The storage devices of memory system 104 represent computer readable storage media that store computer-readable and computer-executable instructions including contract analysis unit 40. Memory system 104 stores instructions and data received from processors 102, input/output devices 106, display devices 108, ports 110, and network devices 112. Memory system 104 provides stored instructions and data to processors 102, input/output devices 106, display devices 108, ports 110, and network devices 112.

The instructions are executable by processing system 100 to perform the functions and methods of contract analysis unit 40 described herein. Examples of storage devices in memory system 104 include hard disk drives, random access memory (RAM), read only memory (ROM), flash memory drives and cards, and other suitable types of magnetic and/or optical disks.

Input/output devices 106 include any suitable type, number, and configuration of input/output devices configured to input instructions and/or data from a user to processing system 100 and output instructions and/or data from processing system 100 to the user. Examples of input/output devices 106 include a touchscreen, buttons, dials, knobs, switches, a keyboard, a mouse, and a touchpad.

Display devices 108 include any suitable type, number, and configuration of display devices configured to output image, textual, and/or graphical information to a user of processing system 100. Examples of display devices 108 include a display screen, a monitor, and a projector.

Ports 110 include suitable type, number, and configuration of ports configured to input instructions and/or data from another device (not shown) to processing system 100 and output instructions and/or data from processing system 100 to another device.

Network devices 112 include any suitable type, number, and/or configuration of network devices configured to allow processing system 100 to communicate across one or more wired or wireless networks (not shown). Network devices 112 may operate according to any suitable networking protocol and/or configuration to allow information to be transmitted by processing system 100 to a network or received by processing system 112 from a network.

Although specific embodiments have been illustrated and described herein for purposes of description of the embodiments, it will be appreciated by those of ordinary skill in the art that a wide variety of alternate and/or equivalent implementations may be substituted for the specific embodiments shown and described without departing from the scope of the present disclosure. Those with skill in the art will readily appreciate that the present disclosure may be implemented in a very wide variety of embodiments. This application is intended to cover any adaptations or variations of the disclosed embodiments discussed herein. Therefore, it is manifestly intended that the scope of the present disclosure be limited by the claims and the equivalents thereof.

What is claimed is:

1. A method performed by at least one processing system, the method comprising:
comparing at least first and second contracts having different lengths using uncertainty information corresponding to a non-overlap period between the first and the second contracts; and
providing an output that represents a comparison between the first and the second contract in view of the uncertainty information.

2. The method of claim 1 further comprising:
determining an optimal contract between the first contract and the second contract using the output.

3. The method of claim 1 further comprising:
generating first cost information corresponding to the first contract using the uncertainty information;
generating second cost information corresponding to the second contract; and
generating the output based on the first and the second cost information.

4. The method of claim 1 wherein the uncertain information includes at least one of price uncertainty, demand uncertainty, or discount rate uncertainty.

5. The method of claim 4 wherein the uncertain information includes at least two of price uncertainty, demand uncertainty, or discount rate uncertainty.

6. The method of claim 1 further comprising:
providing a user interface that allows a user to enter the uncertainty information.

7. The method of claim 6 wherein the user interface allows the user to enter first and second sets of terms for the first and second contracts, respectively.

8. A computer-readable storage medium storing instructions that, when executed by a processing system, perform a method comprising:
providing a user interface that allows a user to enter uncertainty information corresponding to a non-overlap period between first and second contracts having different contract lengths; and
providing an output that represents a comparison between the first and the second contracts in view of the uncertainty information.

9. The computer-readable storage medium of claim 8, wherein the user interface allows the user to enter first and second sets of terms corresponding to the first and the second contracts.

10. The computer-readable storage medium of claim 8, wherein the user interface allows the user to adjust the uncertainty information subsequent to the output being provided.

11. The computer-readable storage medium of claim 8, wherein the uncertain information includes at least one of price uncertainty, demand uncertainty, or discount rate uncertainty.

12. A method performed by at least one processing system, the method comprising:
generating a first aggregate expected cost of a first contract having a first length;
generating a second aggregate expected cost of a second contract having a second length using uncertainty information, the uncertainty information corresponding to a period between an end of the first length and an end of the second length; and
providing an output that represents a comparison of the first and the second aggregate expected costs.

13. The method of claim 12 wherein the output allows a user to identify an optimal contract between the first contract and the second contract.

14. The method of claim 12 wherein the uncertain information includes at least one of price uncertainty, demand uncertainty, or discount rate uncertainty

15. The method of claim 12 further comprising:
providing a user interface that allows a user to enter first and second sets of terms for the first and second contracts, respectively, and the uncertainty information.
